(19) United States
(12) Patent Application Publication
(10) Pub. No.: US 2019/0101099 A1
(43) Pub. Date: Apr. 4, 2019

(54) APPARATUS FOR EXTRACTING OR GENERATING POWER

(71) Applicant: Kitefarms LLC, Laramie, WY (US)

(72) Inventor: Robert LUMLEY, Laramie, WY (US)

(73) Assignee: Kitefarms LLC, Laramie, WY (US)

(21) Appl. No.: 16/087,523

(22) PCT Filed: Mar. 21, 2017
(86) PCT No.: PCT/US17/23445

§ 371 Date: Sep. 21, 2018

Related U.S. Application Data
(60) Provisional application No. 62/311,281, filed on Mar. 21, 2016.

(51) Int. Cl. F03D 5/04; F03D 9/25

(52) U.S. Cl. CPC F03D 5/04; F05B 2220/707; F05B 2220/7068; F03D 9/25

(57) ABSTRACT

An apparatus comprising: a traveler connected to an elongate track; a stator comprising an elongate conductor spaced from the elongate track, a first ferromagnetic unit, and a second ferromagnetic spaced from the first ferromagnetic unit, wherein each ferromagnetic unit comprises a first end proximal to the conductor and a second end distal to the conductor; and a translator coupled to the traveler comprising a base partially surrounding the conductor and extensions positioned on either side of a sequence of ferromagnetic units.

### CROSS-REFERENCE TO RELATED APPLICATION

This application claims the benefit of U.S. Provisional Application No. 62/311,281, filed Mar. 21, 2016, the content of which is incorporated herein by reference in its entirety for all purposes.

### FIELD OF THE DISCLOSURE

This disclosure generally relates to renewable energy. More specifically, this disclosure describes apparatuses and methods for extracting power from fluid flow.

### BACKGROUND OF THE INVENTION

Extracting power from fluid flow is a prominent source of renewable energy. Mainstream examples include wind power and hydropower.

Traditional systems for extracting power from fluid flow are primarily turbine-based. In a turbine, one or more blades are rotatable about a central point, which is rigidly attached to an anchor (typically a tower). The blades are placed within the flowing fluid, which induces a rotation of the blades, and the rotation is converted to electricity.

Turbines may suffer from a number of drawbacks. For example, the forces exerted on a turbine are proportional to the cube of the length of the turbine blades. As the turbine blades increase in size, destructive forces (the moment about the hub on a tower, for example) are cubed. By contrast, usable power is only squared.

This “square-cube” law places significant restrictions on the scale of turbines. Inevitably, the gain of additional power extracted from greater size is not offset by the cost of addressing an increase in destructive forces. For at least this reason, turbine scale is limited.

Other known solutions eliminate towers or other rigid anchors. Examples of such power extraction systems include airborne wind energy systems (“AWE”). Typically, these systems are aerodynamic bodies tethered to the ground (a kite, for example) which fly at altitudes above the height of wind turbines.

There are two main mechanisms for extracting power from an AWE's movement through air: on-board power generation and ground-based power generation. An example of the former includes a turbine on the kite which generates electricity in the same way as the turbines discussed above. An example of the latter includes a long tether attached to a drum, where movement of the kite unrolls the tether from the drum, which rotates the drum and a connected generator, thus converting wind power into electricity.

AWEs may also suffer from a number of drawbacks. For example, because the system requires a tether angled to the airborne object, the power extracted will be a function of the available power and the cosine of the tether angle. Thus, the power extracted may never equal the available power. In addition, the tether will create drag as it moves through the air, slowing the kite, and thus reducing the harvested power. Finally, high-flying AWEs are subject to aviation restrictions, which limit their geographic scope (due to no-fly zones, for example) and present regulatory hurdles for implementation.

### SUMMARY

Examples of the disclosure are directed toward apparatuses and methods for extracting power from fluid flow that overcome the above-identified drawbacks.

One example includes apparatus for extracting power from fluid flow comprising: a traveler connected to an elongate track; a stator comprising an elongate conductor spaced from the elongate track, a first ferromagnetic unit, and a second ferromagnetic spaced from the first ferromagnetic unit, wherein each ferromagnetic unit comprises a first end proximal to the conductor and a second end distal to the conductor; and a translator coupled to the traveler comprising a base partially surrounding the conductor and extensions positioned on either side of a sequence of ferromagnetic units, wherein a width of each extension narrows from the base to an end distal to the conductor, wherein each extension comprises a first permanent-magnet layer with a magnetic flux oriented in a first direction, a first ferromagnetic layer, a second permanent-magnet layer with a magnetic flux oriented in a second direction, and a second ferromagnetic layer, wherein the first direction and second direction are opposite, and wherein the first ferromagnetic layer on one side of the sequence of ferromagnetic units is continuously connected to and offset from the first ferromagnetic layer on the second side of sequence of ferromagnetic units.

In some examples, the conductor is electrically coupled to an inverter.

In some examples, the first ferromagnetic unit couples the conductor and the track. In some examples, the first ferromagnetic unit rigidly couples the conductor and the track. In some examples, the first ferromagnetic unit is coupled at the proximal end to the conductor and the distal end to the track.

Some examples include an oval conductor. The oval conductor includes the elongate conductor, an arcuate conductor, a first conductor section connected at one end to the elongate conductor and another end to the arcuate conductor, and a second conductor section connected to the arcuate conductor. Some examples include a first electric circuit comprising the elongate conductor; a second electric circuit comprising the first conductor section; a third electric circuit comprising the arcuate conductor; and a fourth electric circuit comprising the second conductor section. Some examples include an arcuate conductor thinner than the elongate conductor.

Some embodiments include an oval track comprising the elongate track, wherein the elongate conductor is positioned inside the oval track.

In some examples, the conductor is spaced three inches from the elongate track.

In some examples, the first permanent-magnet layer is adjacent the first ferromagnetic layer, wherein the first ferromagnetic layer is adjacent the second permanent-magnet layer, and wherein the second permanent-magnet layer is adjacent the second ferromagnetic layer. In some examples, a third permanent-magnet layer adjacent the second ferromagnetic layer, a third ferromagnetic layer adjacent the third permanent-magnet layer, a fourth permanent-magnet layer adjacent the third ferromagnetic layer, and a fourth ferromagnetic layer adjacent the fourth permanent-magnet layer.

In some examples, the first permanent-magnet layer does not surround the conductor. In some examples, the second permanent-magnet layer does not surround the conductor.

In some examples, the base of the translator comprises an inner edge proximal the conductor and an outer edge distal the conductor, wherein the inner edge and outer edge comprise concentric arcs. In some examples, the concentric arcs couple to the extension.

In some examples, a plurality of travelers couple to a corresponding plurality of translators.

In some examples, a method for extracting power from fluid flow includes providing an elongate track; connecting a traveler to the elongate track; spacing a stator from the elongate track, wherein the stator comprises an elongate conductor, a first ferromagnetic unit, and a second ferromagnetic spaced from the first ferromagnetic unit, wherein each ferromagnetic unit comprises a first end proximal to the conductor and a second end distal to the conductor; and coupling a translator to the traveler, wherein the translator comprises a base partially surrounding the conductor and extensions positioned on either side of the sequence of ferromagnetic units, wherein a width of each extension narrows from the base to an end distal to the conductor, wherein each extension comprises a first permanent-magnet layer with a magnetic flux oriented in a first direction, a first ferromagnetic layer, a second permanent-magnet layer with a magnetic flux oriented in a second direction, and a second ferromagnetic layer, wherein the first direction and second direction are opposite, and wherein the first ferromagnetic layer on one side of a sequence of ferromagnetic units is continuously connected to and offset from the first ferromagnetic layer on the second side of the sequence of ferromagnetic units.

In some examples, the method includes electrically coupling the conductor to an inverter.

In some examples, the method includes coupling the conductor and the track with the first ferromagnetic unit. In some examples, the method includes coupling the first ferromagnetic unit at the proximal end to the conductor and the distal end to the track. In some examples, the method includes rigidly coupling the conductor and the track with the first ferromagnetic unit.

In some examples, the stator further comprises an oval conductor, wherein the oval conductor comprises the elongate conductor, an arcuate conductor, a first conductor section connected at one end to the elongate conductor and another end to the arcuate conductor, and a second conductor section connected to the arcuate conductor, and the method further comprises: generating electric current in a first electric circuit comprising the elongate conductor; generating electric current in a second electric circuit comprising the first conductor section; generating electric current in a third electric circuit comprising the arcuate conductor; and generating electric current in a fourth electric circuit comprising the second conductor section.

In some examples, the stator includes an oval conductor, wherein the oval conductor comprises the elongate conductor and an arcuate conductor thinner than the elongate conductor.

In some examples, the method includes providing an oval track, wherein the oval track comprises the elongate track; and spacing the elongate conductor inside the oval track.

In some examples, the conductor is spaced three inches from the elongate track.

In some examples, the first permanent-magnet layer is adjacent the first ferromagnetic layer, wherein the first ferromagnetic layer is adjacent the second permanent-magnet layer, and wherein the second permanent-magnet layer is adjacent the second ferromagnetic layer. In some examples, the translator further comprises a third permanent-magnet layer adjacent the second ferromagnetic layer, a third ferromagnetic layer adjacent the third permanent-magnet layer, a fourth permanent-magnet layer adjacent the third ferromagnetic layer, and a fourth ferromagnetic layer adjacent the fourth permanent-magnet layer.

In some examples, the permanent-magnet layer does not surround the conductor. In some examples, the second permanent-magnet layer does not surround the conductor.

In some examples, the base of the translator comprises an inner edge proximal the conductor and an outer edge distal the conductor, and wherein the inner edge and outer edge comprise concentric arcs. In some examples, the concentric arcs couple to the extension.

In some examples, the method includes coupling a plurality of translators to a corresponding plurality of travelers.

### BRIEF DESCRIPTION OF THE DRAWINGS

FIGS. 1A and 1B illustrate an exemplary power extraction apparatus according to examples of the disclosure. FIG. 1A illustrates the apparatus viewed in a direction of flow of an atmospheric wind. FIG. 1B illustrates the apparatus in a side, cut-away view.

FIGS. 2A-2C illustrate an exemplary translator according to examples of the disclosure. FIG. 2A provides an isometric view of the translator. FIG. 2B provides a top view of the translator. FIG. 2C provides another example of the translator.

FIGS. 3A-3C illustrate an exemplary translator according to examples of the disclosure. FIG. 3A provides an isometric view of the translator. FIG. 3B provides a top view of the translator. FIG. 3C provides another example of the translator.

FIG. 4 illustrates exemplary circuits according to examples of the disclosure.

FIG. 5 illustrates a method of extracting power according to examples of the disclosure.

### DETAILED DESCRIPTION

In the following description of embodiments, reference is made to the accompanying drawings which form a part hereof, and in which it is shown by way of illustration specific embodiments which can be practiced. It is to be understood that other embodiments can be used and structural changes can be made without departing from the scope of the disclosed embodiments.

Examples of the disclosure are power-extraction apparatuses that includes a traveler connected to an elongate track, a stator, and a translator. The stator includes an elongate conductor spaced from the elongate track, a first ferromagnetic unit, and a second ferromagnetic spaced from the first ferromagnetic unit. Each ferromagnetic unit can include a first end proximal to the conductor and a second end distal to the conductor. The translator can be coupled to the traveler. The traveler can include a base partially surrounding the conductor and extensions positioned on either side of the sequence of ferromagnetic units. In some examples, a width of each extension narrows from the base to an end distal to the conductor.

In some examples, methods of extracting power include providing an elongate track, connecting a traveler to the elongate track, spacing a stator from the elongate track, and coupling a translator to the traveler. The stator includes an elongate conductor, a first ferromagnetic unit, and a second ferromagnetic spaced from the first ferromagnetic unit, wherein each ferromagnetic unit includes a first end proximal to the conductor and a second end distal to the conductor. The translator can include a base partially surrounding the conductor and extensions positioned on either side of the sequence of ferromagnetic units.

Examples of the invention are described with respect to the wind generating apparatus of U.S. Pat. No. 9,121,377, which is incorporated herein by reference in its entirety for all purposes. However, reference to the wind-generating apparatus of U.S. Pat. No. 9,121,377 is exemplary. One of skill in the art will appreciate that the wind-generating apparatus of U.S. Pat. No. 9,121,377 does not limit this disclosure.

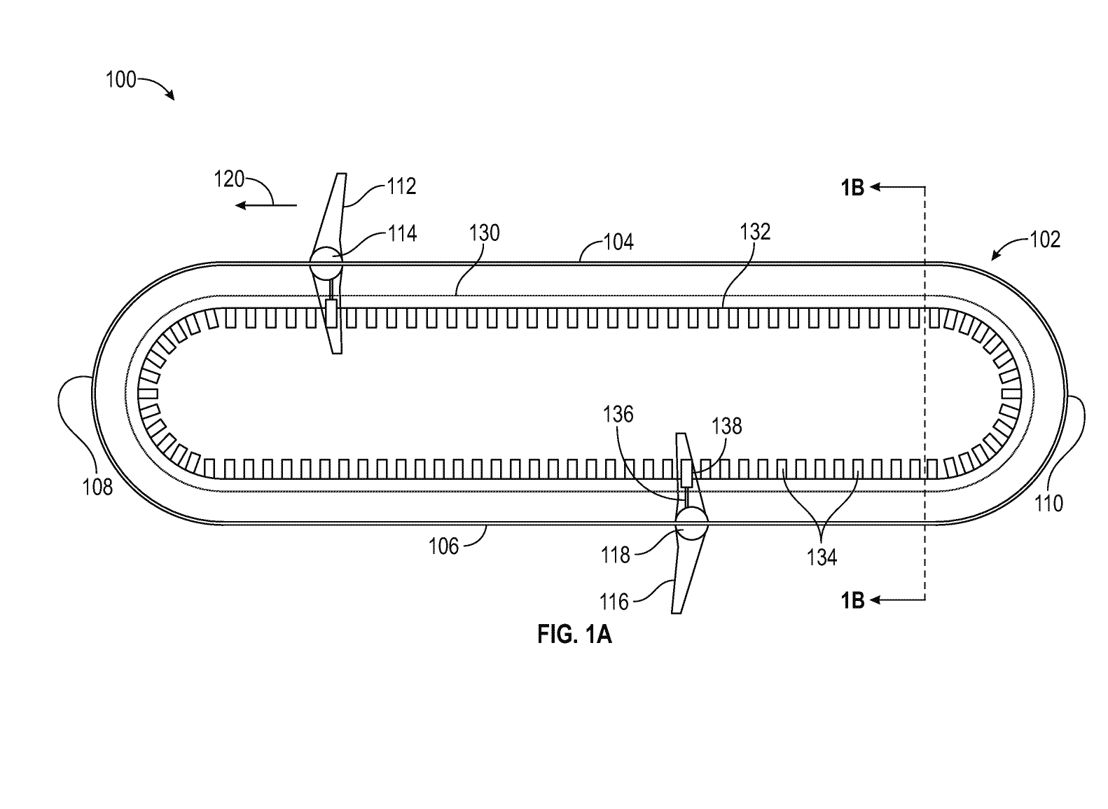

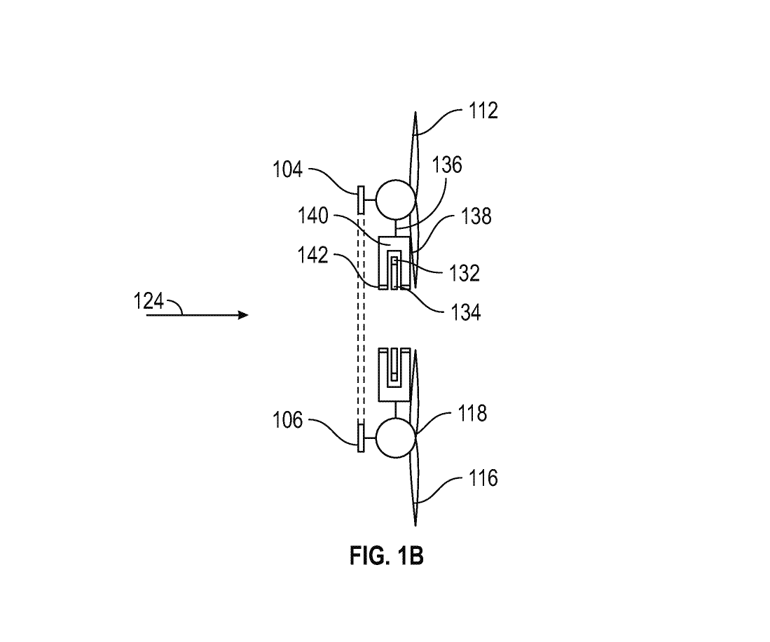

FIGS. 1A and 1B illustrate an exemplary apparatus 100 for extracting power according to examples of the disclosure. FIG. 1A illustrates the apparatus viewed in a direction opposite to the flow of an atmospheric wind 124. FIG. 1B illustrates the apparatus in a side, cut-away view from the dashed line in FIG. 1A and looking toward end 108.

Apparatus 100 includes airframes 112 and 116 traveling on an upper elongate section 104 and a lower elongate section 106, respectively. Elongate sections 104 and 106 are components of track 102, which also includes terminals 108 and 110.

More generally, airframes 112 and 116 represent travelers moving in a fluid flow (an atmospheric wind in the example of FIGS. 1A and 1B). Travelers 112 and 116 are coupled to track 102 through carriers 114 and 118. The tracks are oriented so that the airframes travel crosswind with respect to the atmospheric wind 124. As used herein, an object may be understood to be traveling “crosswind” when the object's direction of travel is not aligned with a direction of an atmospheric wind. The atmospheric wind may be a prevailing wind, but need not be so limited.

Travelers 112 and 116 travel in opposite directions 120 and 122 on the upper and lower sections 104 and 106, respectively. The travelers change from the upper to the lower section along terminal 108 and from the lower to the upper section on terminal 110. Travel along a terminal also causes a change in direction of the airframes.

Electricity may be captured from the motion of the travelers using converter 130. Converter 130 includes an elongate conductor 132 spaced from the track 102 and a plurality of ferromagnetic units 134. Each ferromagnetic unit comprises a first end proximal to the conductor and a second end distal to the conductor. Together, elongate conductor 132 and the plurality of ferromagnetic units 134 can be considered the stator of converter 130.

Elongate conductor 132 may take a variety of cross-sectional shapes. In some examples, the cross-sectional shape is one of circular or rectangular. In some examples, the conductor's cross-sectional shape varies along its length or differs from the cross-sectional shape from another conductor in apparatus 100.

Converter 130 also includes a translator 138 connected to a respective traveler 112 and 116 through connection 136. Translator 138 includes a base portion 140 and extensions 142. Base portion 140 partially surrounds elongate conductor 132. Extensions 142 are positioned on either side of the ferromagnetic units 134.

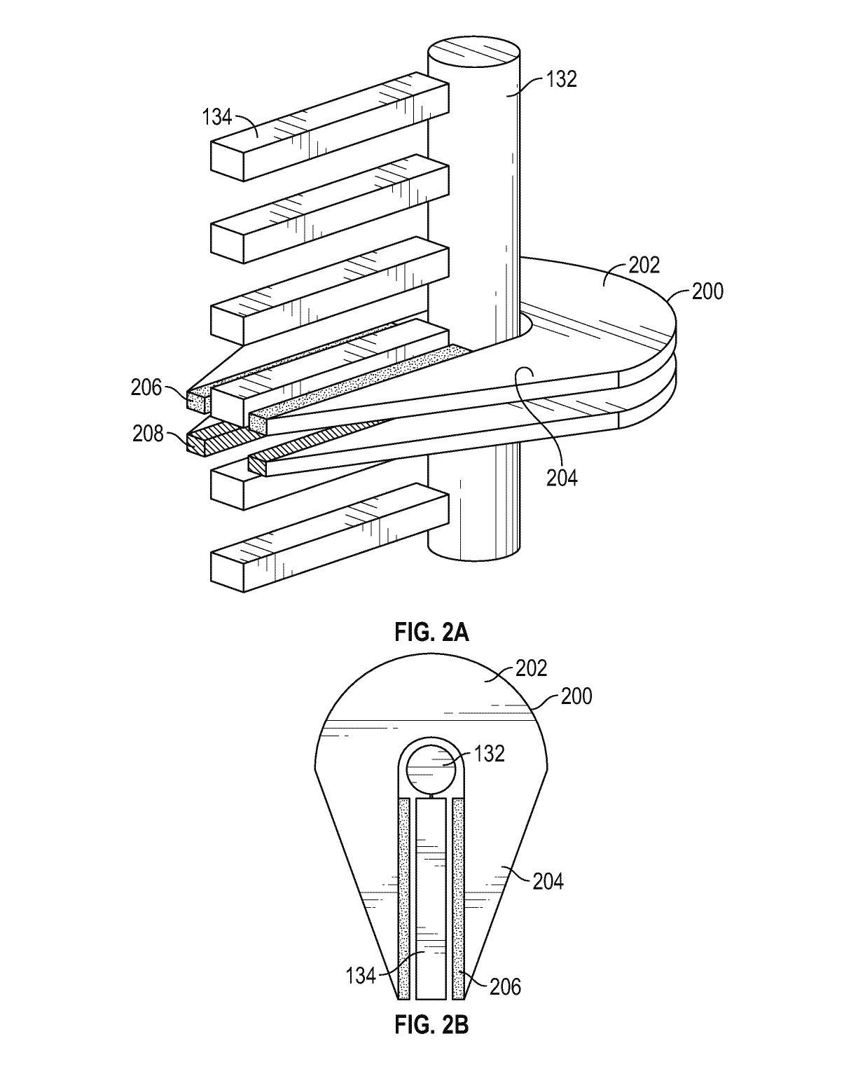

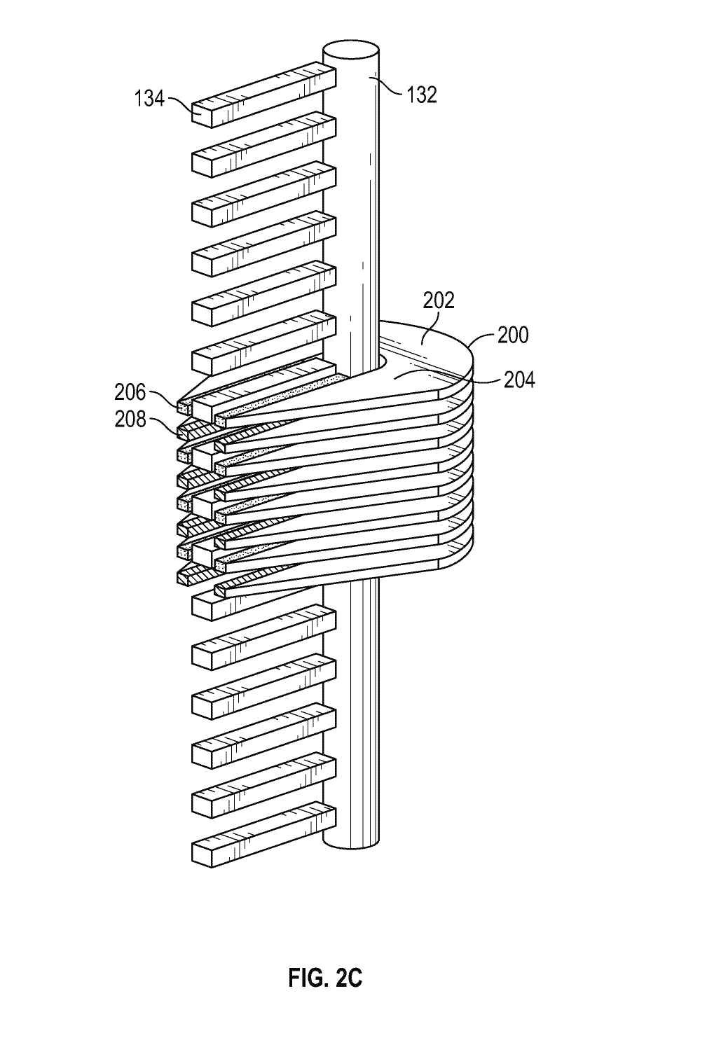

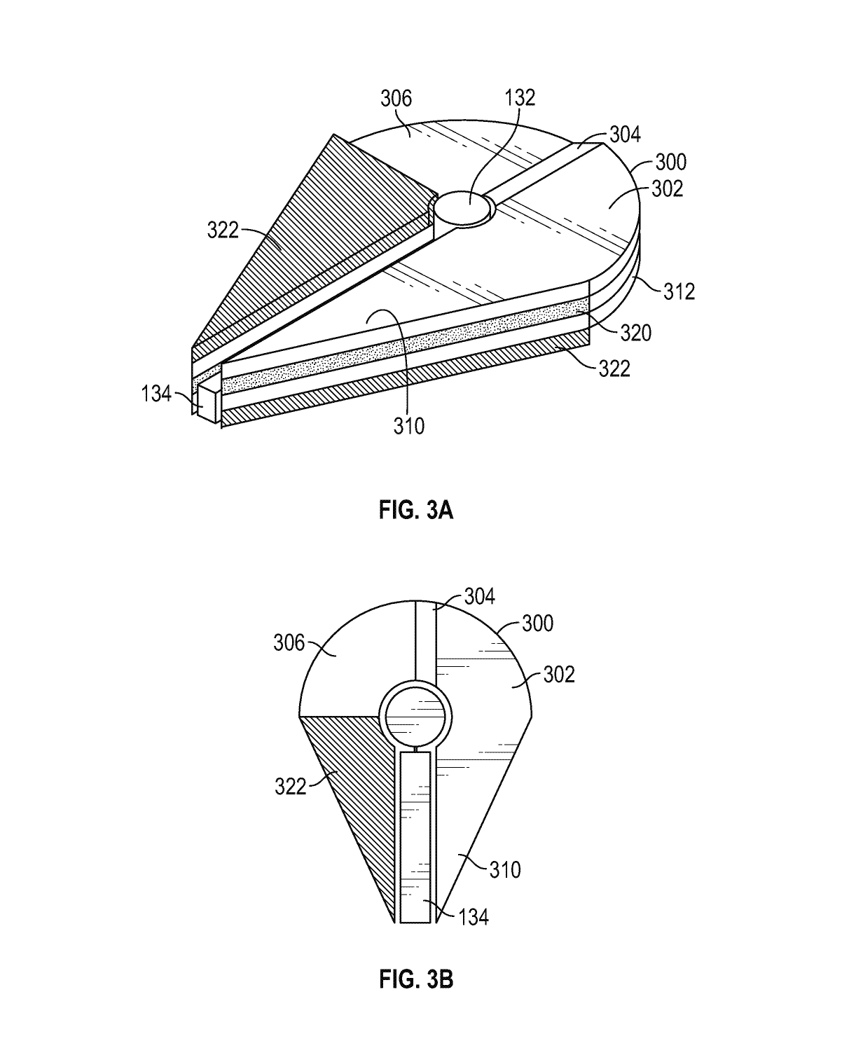

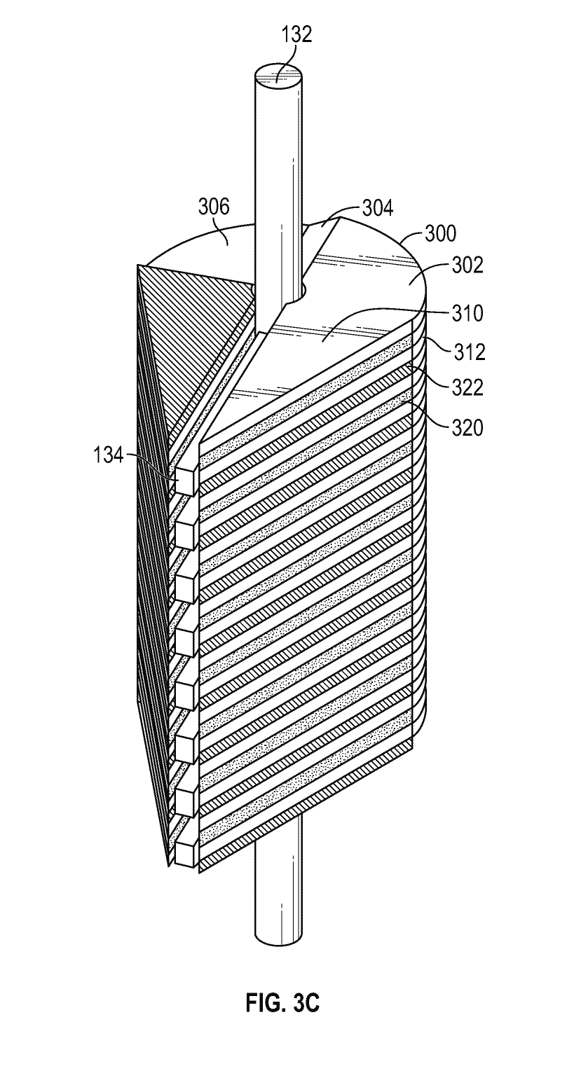

As described in more detail with respect to the examples of FIGS. 2A-3C, each ferromagnetic unit can complete a magnetic circuit in translator 138. The magnetic circuit flows through one extension, through the base portion, through the other extension, and then through the ferromagnetic unit. Because the ferromagnetic units are spaced apart, the magnetic flux is alternatively turned on and off as the translator extensions alternatively pass over the ferromagnetic unit and the space between the ferromagnetic units. The strength of the magnetic flux increases as more of the extension is aligned with the ferromagnetic unit because more surface area of the extension is exposed to the ferromagnetic unit. The strength of the magnetic flux reaches a maximum and thereafter begins to reduce. This changing magnetic flux in the translator induces an electric charge in the conductor. That generated electric charge is then harvested.

In some examples, a width of extensions 142 narrows from the base portion to 140 to an opposite end. This arrangement can advantageously reduce the cost of materials while maintaining the magnetic flux through the translator.

In some examples, the width of the extension at the base portion is a function of the length of a ferromagnetic unit. Material in the translator may have a lower magnetic reluctance than material in the ferromagnetic unit. For this reason, less translator material may maintain the flow of magnetic flux for a given volume of ferromagnetic unit material. In some examples, the width of the extension at the base portion is one half the length of a ferromagnetic unit. In some examples, the width of the extension at the base portion is 1 cm to 10 cm. In some examples, the base portion is approximately 3.5 cm. In some examples, the width of the extension at the opposite end from the base portion is 0.5 cm to 5 cm. In some examples, the width of the extension at the opposite end from the base portion is approximately 0.7 cm.

Connection 136 couples the respective traveler to the translator 138 so that movement of the traveler results in movement of the translator 138. As depicted in FIGS. 1A and 1B, connection 136 couples the traveler to the base portion 140 of the translator 138. In other examples, connection 136 couples the traveler to an extension 142 of the translator 138. In some examples, connection 136 is molded plastic configured to receive a portion of the translator 138 and configured to attach to track 102. In some examples, connection 136 is composed of a non-ferromagnetic case with a hollow space for the magnet/ferrite stack to be inserted. This case is attached to the traveler via screws. As the traveler is propelled, the case is also propelled, alternatively completing and disconnecting the magnetic circuit

In some examples, the ferromagnetic unit couples the elongate conductor and the track 102. In some further examples, the ferromagnetic unit rigidly couples the conductor and the track 102. In some examples, the ferromagnetic unit is coupled at the proximal end to the conductor and the distal end to the track 102. In some examples, the ferromagnetic unit couples the elongate conductor and the track 102, and the base portion 140 of the translator 138 is positioned distal to the track 102 and narrow ends of the extensions are positioned proximal to the track 102.

In some examples, the ferromagnetic units are co-extruded with plastic material or other structural material. In some examples, the ferromagnetic units can be widened at both ends to provide a connection with the conductor and the track, which have complimentary connections to receive the widened ends.

In some examples, a power generation device includes an oval track comprising the elongate track. In some examples, the elongate conductor is positioned inside the oval track. In some examples, the elongate conductor is not positioned inside the oval track, such as parallel to the oval track in a down-wind position. In some examples, the conductor is spaced three inches from the elongate track.

In some examples, the elongate conductor 132 is coincident with the track 102. In some examples, the track 102 is the elongate conductor 132. In some examples, the elongate conductor 132 includes multiple elongate conductors. This arrangement may advantageously increase voltage and/or may advantageously reduce skin effects.

FIGS. 2A-2C illustrate an exemplary translator 200. FIG. 2A provides an isometric view of translator 200. FIG. 2B provides a top view of translator 200. FIG. 2C provides another example of translator 200.

Translator 200 may correspond to translator 138 described above with respect to FIGS. 1A and 1B. For ease of reference, elongate conductor 132 and ferromagnetic units 134 are used in the following description of translator 200. One of skill in the art will recognize that the features of translator 200 are not limited by elongate conductor 132 and ferromagnetic units 134.

Translator 200 includes a base portion 202, extensions 204, and a first permanent magnet pair 206. Second permanent magnet pair 208 is associated with another layer of the translator. The first and second permanent magnets may have magnet fluxes oriented in different directions.

As the translator passes the ferromagnetic units 134, first permanent magnet pair 206 alternatively have a ferromagnetic unit 134 or a gap between them. When first permanent magnet pair 206 has a ferromagnetic unit between them, a magnetic circuit flows through one extension 204, through the base portion 202, through the other extension 204, and then through the ferromagnetic unit 134. Because the ferromagnetic units are spaced apart, the magnetic flux is alternatively turned on and off as the translator extensions alternatively pass over the ferromagnetic unit and the space between the ferromagnetic units.

The strength of the magnetic flux increases as more of the extension is aligned with the ferromagnetic unit because more surface area of the extension is exposed to the ferromagnetic unit. The strength of the magnetic flux reaches a maximum and thereafter begins to reduce. This changing magnetic flux in the translator induces an electric charge in the conductor.

As second permanent magnet pair 208 passes a ferromagnetic unit 134, a magnetic flux is generated in the opposite direction as the magnetic flux associated with first permanent magnet pair 206. This also induces a current in conductor 132, but in an opposite direction as the current induced by the first permanent magnet pair. In this way, translator 200 creates an AC current in conductor 132 as the translator moves in the fluid flow.

As described above with respect to FIGS. 1A and 1B, the translator's magnetic reluctance in some examples may be less than the magnetic reluctance of the ferromagnetic units. In the example of FIGS. 2A-2C, the base portion 202 includes an inner edge proximal the conductor 132 and an outer edge distal the conductor 132, wherein the inner edge and outer edge are concentric arcs. In some examples, the concentric arcs couple to the extensions. Because magnetic flux lines are concentric, base portion 202 can reduce construction material necessary without sacrificing performance.

In some examples, the conductor length is the same length as the track. In other examples, the conductor length is greater than the length of the track. In other examples, the conductor length is less than the length of the track. In some examples, the oval length is 500 m, and the conductor length is 1000 meters. In some examples, the conductor radius is in a range of 3 mm to 25 mm. In some examples, the conductor radius is 6 mm. In some examples, the plurality of ferromagnetic units 134 have a distal length in the range of 25 mm to 100 mm (some examples have a length of approximately 35 mm); a height (dimension parallel to the conductor) in a range of 1 mm to 10 mm (some examples have a height of approximately 6 mm); and a width in a range of 3 mm to 10 mm (some examples have a height of 8 mm). In some examples, the height of one phase (the distance between one pair of plurality of ferromagnetic units and the next pair) is in a range of 10 mm to 40 mm (in some examples the height of one phase is approximately 18 mm). In some examples, a gap between the plurality of ferromagnetic units 134 and the translator extensions 310 is in the range of 0.5 mm to 6 mm (in some examples the gap is approximately 1.5 mm).

FIGS. 3A-3C illustrate an exemplary translator 300. FIG. 3A provides an isometric view of translator 300. FIG. 3B provides a top view of translator 300. FIG. 3C provides another example of translator 300.

Translator 300 may correspond to translator 138 described above with respect to FIGS. 1A and 1B. For ease of reference, elongate conductor 132 and ferromagnetic units 134 are used in the following description of translator 300. One of skill in the art will recognize that the features of translator 300 are not limited by elongate conductor 132 and ferromagnetic units 134.

Translator 300 includes a base portion (302, 304, and 306) and extensions 310. Each extension 310 comprises a first permanent-magnet layer 322 with a magnetic flux oriented in a first direction, a first ferromagnetic layer (310, 302, 304, and 306), a second permanent-magnet layer 320 with a magnetic flux oriented in a second direction, and a second ferromagnetic layer 312. In some examples, the first direction and second direction are opposite.

In some examples, the first ferromagnetic layer on one side of the sequence of ferromagnetic units is continuously connected to and offset from the first ferromagnetic layer on the second side of the sequence of ferromagnetic units. In FIG. 3A, a first section 302 of the base portion is connected to a second section 306 of the base portion through a step 304. Step 304 changes the position of the ferromagnetic layer in a direction of the elongate conductor.

In some examples, the first permanent-magnet layer is adjacent the first ferromagnetic layer, the first ferromagnetic layer is adjacent the second permanent-magnet layer, and the second permanent-magnet layer is adjacent the second ferromagnetic layer. In some examples, the first permanent-magnet layer does not surround the conductor. In some examples, the first permanent-magnet layer does surround the conductor. In some examples, the second permanent-magnet layer does not surround the conductor. In some examples, the second permanent-magnet layer does surround the conductor.

Some examples include a third permanent-magnet layer adjacent the second ferromagnetic layer, a third ferromagnetic layer adjacent the third permanent-magnet layer, a fourth permanent-magnet layer adjacent the third ferromagnetic layer, and a fourth ferromagnetic layer adjacent the fourth permanent-magnet layer.

In some examples, the conductor length is the same length as the track. In other examples, the conductor length is greater than the length of the track. In other examples, the conductor length is less than the length of the track. In some examples, the oval length is 500 m, and the conductor length is 1000 meters. In some examples, the conductor radius is in a range of 3 mm to 25 mm. In some examples, the conductor radius is 6 mm. In some examples, the plurality of ferromagnetic units 134 have a distal length in the range of 25 mm to 100 mm (some examples have a length of approximately 35 mm); a height (dimension parallel to the conductor) in a range of 1 mm to 10 mm (some examples have a height of approximately 6 mm); and a width in a range of 3 mm to 10 mm (some examples have a height of 8 mm). In some examples, the height of one phase (the distance between one pair of plurality of ferromagnetic units and the next pair) is in a range of 10 mm to 40 mm (in some examples the height of one phase is approximately 18 mm). In some examples, a gap between the plurality of ferromagnetic units 134 and the translator extensions 310 is in the range of 0.5 mm to 6 mm (in some examples the gap is approximately 1.5 mm).

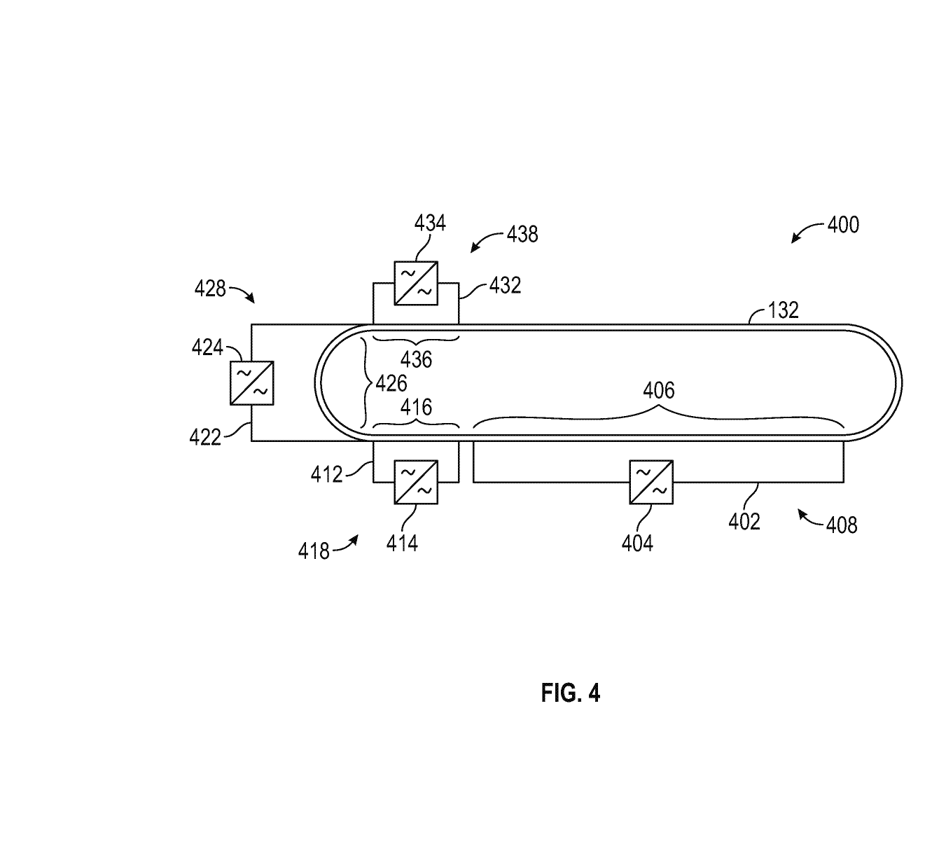

FIG. 4 illustrate exemplary circuits for use with a power generation device 400. Each circuit includes a conductor (402, 412, 422, and 432) and an inverter (404, 414, 424, and 434 respectively) connected to different portions of an oval conductor 132. The oval conductor can include an elongate conductor 406, an arcuate conductor 426, a first conductor section 416 connected at one end to the elongate conductor 406 and another end to the arcuate conductor 426, and a second conductor section 436 connected to the arcuate conductor 426. A first electric circuit 408 includes the elongate conductor 406. A second electric 418 circuit includes the first conductor section 416. A third electric circuit 428 includes the arcuate conductor 426. A fourth electric circuit 438 includes the second conductor section 436.

In some examples, the power generation device 400 is used in conjunction with the apparatuses described above with respect to FIGS. 1A-3C.

In some examples, the travelers move independently of one another. Through multiple circuits, the system may vary the speed of the travelers on different elongate sections and/or vary the number of travelers on each elongate section at any one time. In certain wind circumstances, it may be beneficial to have substantially different speeds, for example, to increase the power extracted from the wind. In some examples, low wind speeds may call for a relatively large number of travelers traveling relatively slowly and, by contrast, high wind speeds may call for a smaller number of travelers traveling relatively quickly. In some examples, a wind direction which is not perpendicular to the direction of travel of a traveler may call for different speeds and/or different number of travelers on the tracks.

In some examples, a width of the arcuate conductor is thinner than the elongate conductor.

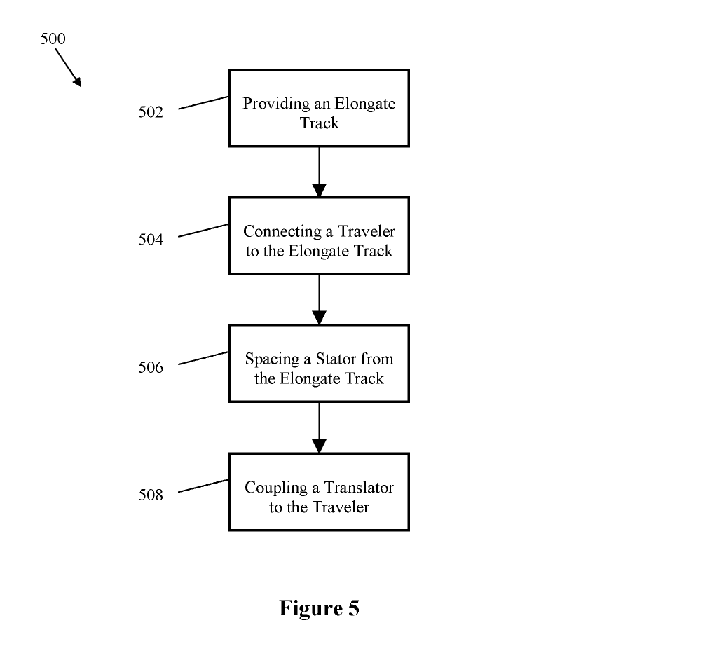

FIG. 5 illustrates a method of extracting power a method 500 for extracting power from fluid flow includes providing 502 an elongate track, connecting 504 a traveler to the elongate track, spacing 506 a stator from the elongate track, and coupling 508 a translator to the traveler. In some examples, the stator comprises an elongate conductor, a first ferromagnetic unit, and a second ferromagnetic spaced from the first ferromagnetic unit, wherein each ferromagnetic unit comprises a first end proximal to the conductor and a second end distal to the conductor. In some examples, the translator comprises a base partially surrounding the conductor and extensions positioned on either side of the sequence of ferromagnetic units. In some examples, a width of each extension narrows from the base to an end distal to the conductor. In some examples, each extension comprises a first permanent-magnet layer with a magnetic flux oriented in a first direction, a first ferromagnetic layer, a second permanent-magnet layer with a magnetic flux oriented in a second direction, and a second ferromagnetic layer. In some examples, the first direction and second direction are opposite. In some examples, the first ferromagnetic layer on one side of a sequence of ferromagnetic units is continuously connected to and offset from the first ferromagnetic layer on the second side of the sequence of ferromagnetic units.

In some examples, the method includes electrically coupling the conductor to an inverter.

In some examples, the method includes coupling the conductor and the track with the first ferromagnetic unit. In some examples, the method includes coupling the first ferromagnetic unit at the proximal end to the conductor and the distal end to the track. In some examples, the method includes rigidly coupling the conductor and the track with the first ferromagnetic unit.

In some examples, the stator further comprises an oval conductor, wherein the oval conductor comprises the elongate conductor, an arcuate conductor, a first conductor section connected at one end to the elongate conductor and another end to the arcuate conductor, and a second conductor section connected to the arcuate conductor, and the method further comprises: generating electric current in a first electric circuit comprising the elongate conductor; generating electric current in a second electric circuit comprising the first conductor section; generating electric current in a third electric circuit comprising the arcuate conductor; and generating electric current in a fourth electric circuit comprising the second conductor section.

In some examples, the stator includes an oval conductor, wherein the oval conductor comprises the elongate conductor and an arcuate conductor thinner than the elongate conductor.

In some examples, the method includes providing an oval track, wherein the oval track comprises the elongate track; and spacing the elongate conductor inside the oval track.

In some examples, the conductor is spaced three inches from the elongate track.

In some examples, the first permanent-magnet layer is adjacent the first ferromagnetic layer, wherein the first ferromagnetic layer is adjacent the second permanent-magnet layer, and wherein the second permanent-magnet layer is adjacent the second ferromagnetic layer. In some examples, the translator further comprises a third permanent-magnet layer adjacent the second ferromagnetic layer, a third ferromagnetic layer adjacent the third permanent-magnet layer, a fourth permanent-magnet layer adjacent the third ferromagnetic layer, and a fourth ferromagnetic layer adjacent the fourth permanent-magnet layer.

In some examples, the permanent-magnet layer does not surround the conductor. In some examples, the second permanent-magnet layer does not surround the conductor.

In some examples, the base of the translator comprises an inner edge proximal the conductor and an outer edge distal the conductor, and wherein the inner edge and outer edge comprise concentric arcs. In some examples, the concentric arcs couple to the extension.

In some examples, the method includes coupling a plurality of translators to a corresponding plurality of travelers.

In some examples, electricity is captured through induction. In this example, the permanent magnets described above are replaced with electromagnets. In some examples, the translator includes a power storage device for initiating the electromagnets. In some examples, the translator includes a conductor for generating electricity to power the electromagnetics. In such embodiments, the charge in the translator conductor is generated by the changing magnetic field associated with the changing current in the elongate conductor.

Although the examples herein have been primarily described with respect to a power generator, one of skill in the art will recognize that the examples herein could also serve as a motor. For example, the translators and stators described above could be fixed to a ski lift and electricity passed through the conductors.

Although the examples herein have been primarily described with respect to a linear generator, one of skill in the art will recognize that other arrangements could be used without deviating from the scope of the present disclosure. For example, one of skill in the art will appreciate that the examples described herein could be used in a rotary generator.

As noted above, the disclosure is not limited to wind-power. Some examples may include other gases or fluids. Exemplary hydropower embodiments may include a river installation or a tidal power installation. In some other examples, the electricity extraction apparatus may be attached to buoyant devices, which may create lift. By manipulation of roll angle (either through structure or active controls), the apparatus can be maintained at a desired depth or height to increase energy capture, for example. When used herein, terms that may suggest a specific application (such as crosswind and atmospheric wind) should be understood to have analogous terms in other fluid flows.

Further, as used herein, the term “elongate section” may be understood to be any structure to which a traveler can be coupled and travel crosswind for distances many times the size of the traveler. An elongate section may not necessarily be linear and may include curves or other non-linear aspects. In some embodiments, an apparatus or method for extracting power may include a single elongate section or multiple elongate sections arranged horizontally, rather than the vertical orientation described herein.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

1.-32. (canceled)

33. An apparatus for extracting power from fluid flow comprising:
a traveler connected to an elongate track;
a stator comprising an elongate conductor spaced from the elongate track, a first ferromagnetic unit, and a second ferromagnetic spaced from the first ferromagnetic unit, wherein each ferromagnetic unit comprises a first end proximal to the conductor and a second end distal to the conductor; and
a translator coupled to the traveler comprising a base partially surrounding the conductor and extensions positioned on either side of a sequence of ferromagnetic units, wherein a width of each extension narrows from the base to an end distal to the conductor, wherein
each extension comprises a first permanent-magnet layer with a magnetic flux oriented in a first direction, a first ferromagnetic layer, a second permanent-magnet layer with a magnetic flux oriented in a second direction, and a second ferromagnetic layer, wherein
the first direction and second direction are opposite, and wherein
the first ferromagnetic layer on one side of the sequence of ferromagnetic units is continuously connected to and offset from the first ferromagnetic layer on the second side of sequence of ferromagnetic units.

34. The apparatus for extracting power from fluid flow of claim 33 wherein the conductor is electrically coupled to an inverter.

35. The apparatus for extracting power from fluid flow of claim 33 wherein the first ferromagnetic unit couples the conductor and the track.

36. The apparatus for extracting power from fluid flow of claim 35 wherein the first ferromagnetic unit rigidly couples the conductor and the track.

37. The apparatus for extracting power from fluid flow of claim 35 wherein the first ferromagnetic unit is coupled at the proximal end to the conductor and the distal end to the track.

38. The apparatus for extracting power from fluid flow of claim 33 further comprising:
an oval conductor comprising
the elongate conductor,
an arcuate conductor,
a first conductor section connected at one end to the elongate conductor and another end to the arcuate conductor, and
a second conductor section connected to the arcuate conductor;
a first electric circuit comprising the elongate conductor;
a second electric circuit comprising the first conductor section;
a third electric circuit comprising the arcuate conductor; and
a fourth electric circuit comprising the second conductor section.

39. The apparatus for extracting power from fluid flow of claim 33 further comprising an arcuate conductor thinner than the elongate conductor.

40. The apparatus for extracting power from fluid flow of claim 33 further comprising an oval track comprising the elongate track, wherein the elongate conductor is positioned inside the oval track.

41. The apparatus for extracting power from fluid flow of claim 33 wherein the conductor is spaced three inches from the elongate track.

42. The apparatus for extracting power from fluid flow of claim 33 wherein the first permanent-magnet layer is adjacent the first ferromagnetic layer, wherein the first ferromagnetic layer is adjacent the second permanent-magnet layer, and wherein the second permanent-magnet layer is adjacent the second ferromagnetic layer.

43. A method for extracting power from fluid flow comprising:
providing an elongate track;
connecting a traveler to the elongate track;
spacing a stator from the elongate track, wherein the stator comprises an elongate conductor, a first ferromagnetic unit, and a second ferromagnetic spaced from the first ferromagnetic unit, wherein each ferromagnetic unit comprises a first end proximal to the conductor and a second end distal to the conductor; and
coupling a translator to the traveler, wherein the translator comprises a base partially surrounding the conductor and extensions positioned on either side of the sequence of ferromagnetic units, wherein
a width of each extension narrows from the base to an end distal to the conductor, wherein
each extension comprises a first permanent-magnet layer with a magnetic flux oriented in a first direction, a first ferromagnetic layer, a second permanent-magnet layer with a magnetic flux oriented in a second direction, and a second ferromagnetic layer, wherein
the first direction and second direction are opposite, and wherein
the first ferromagnetic layer on one side of a sequence of ferromagnetic units is continuously connected to and offset from the first ferromagnetic layer on the second side of the sequence of ferromagnetic units.

44. The method for extracting power from fluid flow of claim 44 further comprising electrically coupling the conductor to an inverter.

45. The method for extracting power from fluid flow of claim 44 further comprising coupling the conductor and the track with the first ferromagnetic unit.

46. The method for extracting power from fluid flow of claim 45 further comprising coupling the first ferromagnetic unit at the proximal end to the conductor and the distal end to the track.

47. The method for extracting power from fluid flow of claim 45 further comprising rigidly coupling the conductor and the track with the first ferromagnetic unit.

48. The method for extracting power from fluid flow of claim 44 further comprising:
providing an oval track, wherein the oval track comprises the elongate track; and
spacing the elongate conductor inside the oval track.

49. The method for extracting power from fluid flow of claim 48 wherein the conductor is spaced three inches from the elongate track.

50. The method for extracting power from fluid flow of claim 44 wherein the first permanent-magnet layer does not surround the conductor.

51. The method for extracting power from fluid flow of claim 44 wherein the base of the translator comprises an inner edge proximal the conductor and an outer edge distal the conductor, and wherein the inner edge and outer edge comprise concentric arcs.

52. The method for extracting power from fluid flow of claim 44 wherein the concentric arcs couple to the extension.
